(19) United States
(12) Patent Application Publication
(10) Pub. No.: US 2016/0168030 A1
(43) Pub. Date: Jun. 16, 2016

(54) EPOXY RESIN-UPGRADED CEMENT-BOUND COMPOSITION AS COATING OR SEAL

(71) Applicant: SIKA TECHNOLOGY AG, Baar (CH)

(72) Inventors: David TEICHERT, Kornwestheim (DE); Lars CONRAD, Stuttgart (DE); Jochen GRÖTZINGER, Schwäbisch Gmünd (DE)

(73) Assignee: SIKA TECHNOLOGY AG, Baar (CH)

(21) Appl. No.: 14/904,884

(22) PCT Filed: Jul. 14, 2014
(86) PCT No.: PCT/EP2014/065042

§ 371 Date: Jan. 13, 2016

(30) Foreign Application Priority Data
Jul. 16, 2013 (EP) 13176718.8

(51) Int. Cl. C04B 26/14; C04B 28/02

(52) U.S. Cl. CPC C04B 26/14; C04B 28/02

(57) ABSTRACT

A multicomponent composition is described, including A) a binder component (A) including at least one epoxy resin, B) an aqueous hardener component (B) including at least one amine compound as amine hardener and water and C) a solid component including at least one hydraulic inorganic binder, preferably cement, wherein the multicomponent composition, based on the total weight, includes at least 8% by weight of organic binder, where the total amount of epoxy resin and amine hardener constitutes the organic binder. The multicomponent composition preferably includes at least one pigment as colorant. The multicomponent composition is of outstanding suitability for production of floor coatings or seals, which can be produced in a great variety of hues.

### TECHNICAL FIELD

The invention relates to a multicomponent composition, to a method for producing a coating with the multicomponent composition, and to the use of the multicomponent composition as mortar, seal, or coating.

### PRIOR ART

For floor coating systems there is a partly diverse profile of requirements. Desired properties for floor coatings may be, for example, an aesthetically appealing appearance, a high mechanical robustness, or resistance toward chemicals. Other requirements are, for example, good workability, low yellowing, the use of eco-friendly components, and temperature stability.

Employed frequently nowadays in practice for floor coatings are organic or organic-inorganic hybrid systems. Examples are solvent-free reactive epoxy resin coatings, aqueous epoxy resin coatings, polymer-modified cementitious systems (PCC) such as epoxy resin-modified cementitious systems (ECC) or polyurethane-modified cementitious systems.

It is frequently difficult in this context to combine different properties, some of which are contradictory in terms of their physical requirements, within a floor coating system. While common systems have good properties in respect, for example, of some requirements, the properties of the system in other respects are frequently unsatisfactory.

When using solvent-free reactive epoxy resin coatings, for example, a freshly prepared concrete surface can generally not be coated until after 28 days, since the residual moisture content of the concrete must not exceed 4%. On account of the deficient capacity for diffusion on the part of the reactive epoxy resin coating, the concrete requires protection from water ingress, since otherwise there is a risk of bubbles forming in the reactive epoxy resin coating. Moreover, reactive resin-based coatings are usually subject to visual changes (yellowing) brought about as a result of UV light.

The mechanical and chemical stability of water-based epoxy resin coatings is relatively low.

To date it has not been possible to manufacture epoxy resin-modified cementitious systems in the desired palette of shades, and they have therefore not been used as a final coat in the decorative segment. Furthermore, these products have a dully matt appearance, and the gloss cannot be variably adjusted. Customary epoxy resin-modified cementitious systems have a relatively low organic binder content, of no more than 5 wt %.

Polyurethane-modified cementitious systems generally have a very strong tendency toward yellowing, and possess a very short working time, leading to problems at high temperatures in practical use. Furthermore, such systems may include ingredients suspected of being carcinogenic. On account of the severe yellowing, these systems are also available only in a narrow palette of shades.

DE 10150600 A1 relates to a two-pack bonding mortar produced from a powder component A) comprising 0.5 to 10 parts by weight of an epoxy resin, 10 to 70 parts by weight of fillers, 5 to 20 parts by weight of a cement-containing binder, and 0.1 to 5 parts by weight of additives, and from a liquid component B) comprising 0.5 to 10 parts by weight of an amine hardener, 2 to 10 parts by weight of water, 0 to 5 parts by weight of a plasticizer, and 10 to 50 parts by weight of an aqueous polymer dispersion.

JP H07-315907 A relates to a composition which comprises an epoxy resin, a hardener, Portland cement, calcium aluminate cement, gypsum, and a lithium compound.

### PRESENTATION OF THE INVENTION

The object of the invention was therefore to provide a composition allowing the production of floor coatings which have a balanced profile of properties and which no longer have the above-described disadvantages of the prior-art systems. The intention more particularly is to provide a floor coating having high mechanical and chemical stability which at the same time allows a wide palette of shades and an appealing appearance.

It has been possible, surprisingly, to achieve the object by means of an organic-inorganic hybrid composition having a relatively high organic binder fraction. The composition is highly compatible with commercial, pigment-based color paste systems, allowing the coating to be produced as and when required in a broad palette of shades.

The invention therefore relates to a multicomponent composition comprising
A) a binder component (A) comprising at least one epoxy resin,
B) an aqueous hardener component (B) comprising at least one amine compound as amine hardener and water, and
C) a solid component (C) comprising at least one hydraulic inorganic binder, preferably cement,
   wherein the multicomponent composition, based on the total weight, comprises at least 8 wt % of organic binder, the total amount of epoxy resin and amine hardener constituting the organic binder. In one preferred embodiment the multicomponent composition comprises at least one pigment as colorant, in order to obtain colored coatings or seal. The principal difference between coating and sealing here lies in the amount of the composition of the invention that is applied. The composition of the invention is referred to as a seal if a relatively small amount of material is applied, to give film thicknesses of up to about 500 μm. Film thicknesses greater than this are generally referred to as coatings, although there is no sharp cutoff between a seal and a coating.

The multicomponent composition is outstandingly suitable for producing seals or coatings, more particularly floor coatings or floor seals, and allows the following properties to be combined with one another in one product:
it can be used as a coating with or without primer
it can be used on “fresh” or “green” concrete; i.e., the substrate may have a high residual moisture content
the resulting coatings are of high mechanical strength and high abrasion resistance and are also low in yellowing; furthermore, they are more chemical-resistant than conventional reactive resin systems, and are temperature-stable, open to vapor diffusion, and impervious to liquid
the composition can be given a low-VOC (volatile organic components) or VOC-free formulation; it is eco-friendly and water-thinnable, and apparatus used for its working can be cleaned with water; as a result of the relatively high inorganic fraction, it is sustainable
compatibility with commercially available color paste systems allows a broad palette of shades
smooth or rough surfaces (antislip) can be provided
the composition is inexpensive, has outstanding working properties, and can be worked either kneeling or standing
the gloss of the resulting coating can be adjusted arbitrarily from matt to glossy
curing of the composition is quicker and hence downtime is shorter than for epoxy resin-based products, for example.

Preferred embodiments of the composition are reproduced in the dependent claims. The invention is elucidated comprehensively below.

### WAY OF PERFORMING THE INVENTION

Compound names beginning with “poly” denote substances which formally per molecule contain two or more of the functional groups which occur in their names. The compound may be monomeric, oligomeric or polymeric. A polyamine, for example, is a compound having two or more amino groups. A polyepoxide is a compound having two or more epoxy groups.

Epoxy resins are polyepoxides, i.e. compounds having two or more epoxide groups. Epoxy resins are preferably oligomeric or polymeric compounds. Epoxy resins are sometimes also used in conjunction with what are known as reactive diluents. Reactive diluents are mono- or polyepoxides. The reactive diluents possess a viscosity lower than that of the epoxy resin used, and serve to reduce the viscosity of the epoxy resin used. The optional reactive diluent is likewise incorporated into the organic binder matrix, and for the purpose of determining the organic binder content is therefore counted here among the epoxy resins.

The epoxide equivalent weight (EEW) can be determined according to DIN 53188 and is reported in g/eq. The NH equivalent weight can be determined according to DIN 16945 and is reported in g/eq. The stoichiometric ratio of epoxide functionality to amine functionality is the quotient formed between epoxide equivalent weight and NH equivalent weight, and is frequently reported in %. The NH equivalent weight here refers to the active NH hydrogens. A primary amine, for example, has two active NH hydrogens.

The composition of the invention comprises a multicomponent composition, meaning that the composition comprises a plurality of, more particularly three or more, individual components, which are mixed with one another only at use. Before use, the components are stored separately, in order to prevent spontaneous reaction. For use, the components are mixed with one another.

Mixing is followed by the start of inorganic hydration reactions and organic crosslinking reactions, leading ultimately to the curing of the mixture.

The composition of the invention comprises a binder component (A), a hardener component (B), and a solid component (C). It may be a three-pack composition, consisting only of these three components. Alternatively, as and when required, the composition may also comprise one or more, further, additional components. If, for example, in the preferred embodiment, the multicomponent composition of the invention comprises pigments as colorants, these pigments may be present in at least one of the three stated components (A), (B) or (C) and/or in an additional pigment component (D).

It is clear that the fraction of a particular ingredient in the mixture of the components is dependent on the fraction of that ingredient in the component in question and on the mixing ratio of the components. Unless otherwise indicated, fractions or ratios of particular ingredients that are reported here are based on the appropriate or suitable weight fractions or weight ratios of the ingredients in the mixture of the components of the multicomponent composition. This composition is obtained, for example, by mixing of the components in suitable mixing ratios in accordance with usage instructions.

The multicomponent composition is an organic-inorganic hybrid composition where both the organic binder and the inorganic binder have binder function—that is, both binders can form a matrix for embedding solid particles and for attachment to a substrate.

The binder component (A) comprises at least one epoxy resin and optionally a reactive diluent. The binder component (A) is preferably a liquid component. It may be viscous, but is generally pourable.

The binder component (A) comprises at least one epoxy resin. One epoxy resin or a mixture of two or more epoxy resins may be used. Epoxy resins which may be used are all epoxy resins customary within epoxy chemistry.

Epoxy resins may be prepared, for example, in a known way from the oxidation of the corresponding olefins or from the reaction of epichlorohydrin with the corresponding polyols or polyphenols.

Epoxy resins can be divided into liquid epoxy resins and solid epoxy resins. The epoxy resin may have an epoxy equivalent weight, for example, of 156 to 500 g/eq. The epoxy resin is preferably a diepoxide.

In one embodiment, the epoxy resin may be an aromatic epoxy resin. Examples of resins suitable for this purpose are liquid epoxy resins of the formula (I),

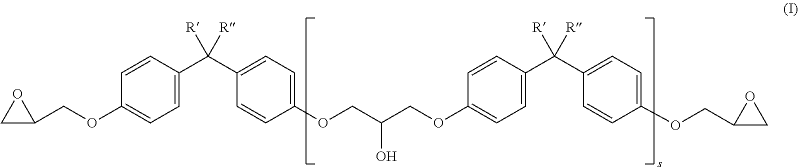

where R′ and R″ independently of one another are each a hydrogen atom or a methyl group, and s is on average a value from 0 to less than 2 and preferably 0 to 1. Preferred liquid resins are those of the formula (I) in which the index s is on average a value of less than 0.2.

The epoxy resins of the formula (I) are diglycidyl ethers of bisphenol A, bisphenol F and bisphenol A/F, with A being acetone and F being formaldehyde, which serve as reactants for the preparation of these bisphenols. Liquid epoxy resins of this kind are available commercially, as for example under the designations Araldite® from Huntsman, D.E.R.® from Dow, Epikote® from Momentive, Epalloy® from CVC, Chem Res® from Cognis or Beckopox® from Cytec.

Further suitable aromatic epoxy resins are the products of glycidylization of:
dihydroxybenzene derivatives such as resorcinol, hydroquinone, and pyrocatechol;
other bisphenols or polyphenols such as bis(4-hydroxy-3-methylphenyl)methane, 2,2-bis(4-hydroxy-3-methylyphenyl)propane (bisphenol-C), bis(3,5-dimethyl-4-hydroxyphenyl)methane, 2,2-bis(3,5-dimethyl-4-hydroxyphenyl)propane, 2,2-bis(3,5-dibromo-4-hydroxypheny)propane, 2,2-bis(4-hydroxy-3-tert-butylphenyl)propane, 2,2-bis(4-hydroxyphenyl)butane (bisphenol-B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol-Z), 1,1-bis(4-hydroxyphenyl)-3,3,5-trimethylcyclohexane (bisphenol-TMC), 1,1-bis(4-hydroxyphenyl)-1-phenylethane, 1,4-bis[2-(4-hydroxyphenyl)-2-propyl]benzene (bisphenol-P), 1,3-bis[2-(4-hydroxyphenyl)-2-propyl]benzene (bisphenol-M), 4,4′-dihydroxybiphenyl (DOD), 4,4′-dihydroxybenzophenone, bis-(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl)ether, bis(4-hydroxyphenyl)sulfone;
condensation products of phenols with formaldehyde, obtained under acidic conditions, such as phenol novolaks or cresol novolaks;
aromatic amines, such as aniline, toluene, 4-aminophenol, 4,4′-methylenediphenyldiamine (MDA), 4,4′-methylenediphenyldi-(N-methyl)amine, 4,4′-[1,4-phenylene-bis(1-methylethylidene)]bisaniline (bisaniline-P), 4,4′-[1,3-phenylene-bis(1-methylethylidene)]bisaniline (bisaniline-M).

In a further embodiment, the epoxy resin may be an aliphatic or cycloaliphatic epoxy resin, such as, for example
diglycidyl ether;
a glycidyl ether of a saturated or unsaturated, branched or unbranched, cyclic or open-chain C₂ to C₃₀ diol, such as ethylene glycol, propylene glycol, butylene glycol, hexanediol, octanediol, a polypropylene glycol, dimethylolcyclohexane, neopentyl glycol, for example;
a glycidyl ether of a tri- or tetrafunctional, saturated or unsaturated, branched or unbranched, cyclic or open-chain polyol such as castor oil, trimethylolpropane, trimethylolethane, pentaerythritol, sorbitol, or glycerol, and also alkoxylated glycerol or alkoxylated trimethylolpropane;
a hydrogenated liquid bisphenol A, F or A/F resin, and/or the products of glycidylization of hydrogenated bisphenol A, F or -A/F;
an N-glycidyl derivative of amides or heterocyclic nitrogen bases, such as triglycidyl cyanurate and triglycidyl isocyanurate, and also reaction products of epichlorohydrin and hydantoin.

Further examples of epoxy resins that can be used are epoxy resins prepared from the oxidation of olefins, as for example from the oxidation of vinylcyclohexene, dicyclopentadiene, cyclohexadiene, cyclododecadiene, cyclododecatriene, isoprene, 1,5-hexadiene, butadiene, polybutadiene or divinylbenzene.

Other examples of epoxy resins which can be used are a solid bisphenol A, F or A/F resin constructed in the same way as for the aforementioned liquid epoxy resins of the formula (I), but with the index s having a value from 2 to 12. Other examples are all aforementioned epoxy resins, given a hydrophilic modification through reaction with at least one polyoxyalkylene polyol.

Preferred as epoxy resin are solid or liquid bisphenol A, F or A/F resins, of the kind available commercially, for example, from Dow, Huntsman and Momentive. Particularly preferred epoxy resins used are diepoxides of a bisphenol A, bisphenol F, and bisphenol A/F diglycidyl ether, more particularly those having an epoxide equivalent weight of 156 to 250 g/eq, examples being the commercial products Araldite® GY 250, Araldite® PY 304, Araldite® GY 282 (from Huntsman); D.E.R.® 331, D.E.R.® 330 (from Dow); Epikote® 828, Epikote® 862 (from Momentive), and of N,N-diglycidylaniline and a polyglycol diglycidyl ether, preferably having an epoxy equivalent weight of 170 to 340 g/eq, examples being the commercial products D.E.R.® 732 and D.E.R.® 736 (from Dow).

The binder component (A) may optionally comprise what is called a reactive diluent. This diluent, as stated, is counted as part of the epoxy resin for the organic binder fraction. One or more reactive diluents may be used. Suitable reactive diluents are mono- and polyepoxides. The addition of a reactive diluent to the epoxy resin has the effect of reducing the viscosity, and also, in the cured state of the epoxy resin composition, of reducing the glass transition temperature and the mechanical values.

Examples of reactive diluents are glycidylethers of mono- or polyhydric phenols and aliphatic or cycloaliphatic alcohols, such as, in particular, the polyglycidyl ethers of diols or polyols, already stated as aliphatic or cycloaliphatic epoxy resins, and also, furthermore, in particular, phenyl glycidyl ether, cresyl glycidyl ether, p-n-butylphenyl glycidyl ether, p-tert-butylphenyl glycidyl ether, nonylphenyl glycidyl ether, allyl glycidyl ether, butyl glycidyl ether, hexyl glycidyl ether, 2-ethylhexyl glycidyl ether, and also glycidyl ethers of natural alcohols, such as, for example, C₈ to C₁₀ alkyl glycidyl ethers, C₁₂ to C₁₄ alkyl glycidyl ethers, or C₁₃ to C₁₅ alkyl glycidyl ethers, available commercially as Erisys® GE-7, Erisys® GE-8 (from CVC), or as Epilox® P 13 - 19 (from Leuna).

The binder component (A) may be nonaqueous. In one preferred embodiment the binder component (A) is an aqueous binder component (A), i.e., it comprises water. The binder component (A) preferably comprises an aqueous epoxy resin dispersion, it being possible for this to be an epoxy resin emulsion, a so-called “emulsifiable epoxy resin”, or an epoxy resin suspension.

A epoxy resin dispersion comprises preferably, besides water, at least one epoxy resin, as stated above, and additionally at least one emulsifier, more particularly a nonionic emulsifier, as for example an alkyl or alkylaryl polyglycol ether, such as a polyalkoxylated alkylphenol such as alkylphenoxypoly(ethyleneoxy)ethanol, an example being a polyadduct of nonylphenol and ethylene oxide containing up to 30 mol of ethylene oxide per mole of nonylphenol or, preferably, an alkoxylated fatty alcohol, an example being an ethoxylated fatty alcohol. Epoxy resin dispersions may have a solids content, for example, in the range of 40-65 wt %.

Commercial epoxy resin dispersions are, for example, Sika® Repair/Sikafloor® EpoCem® Modul A (from Sika Schweiz AG), Araldite® PZ 323, Araldite® PZ 756/67, Araldite® PZ 3961 (from Huntsman), XZ 92598.00, XZ 92546.00, XZ 92533.00 (from Dow), Waterpoxy® 1422, Waterpoxy® 1455 (from Cognis), Beckopox® EP 384w, Beckopox® EP 385w, Beckopox® EP 386w, Beckopox® EP 2340w, Beckopox® VEP 2381w (from Cytec).

An emulsifiable epoxy resin preferably comprises at least one emulsifier, as already mentioned above as a constituent of an epoxy resin dispersion. Commercial emulsifiable epoxy resins are, for example, Araldite® PY 340 and Araldite® PY 340-2 (from Huntsman), Beckopox® 122w and Beckopox® EP 147w (from Cytec).

The binder component (A) may optionally comprise one or more other additives. Suitable additives are elucidated further on below.

The hardener component (B) comprises at least one amine compound as amine hardener and water. The aqueous hardener component (B) is preferably a liquid component. It may be viscous, but is generally pourable.

The amine compound may be any amine compound commonly used in the art as a hardener for epoxy resins. Such amine hardeners are available commercially. One amine compound or two or more amine compounds may be used. Suitable in principle as amine compounds are monoamines, provided the amine is a primary amine, but compounds having at least two amine groups are more preferred. The amino groups may be primary and/or secondary amino groups. It is also possible, optionally to use blocked amine compounds.

Examples of suitable amine compounds as amine hardeners are a polyamine, a polyaminoamide, a polyamine-polyepoxide adduct or a polyaminoamide-polyepoxide adduct, and mixtures thereof, containing in each case in particular at least two amino groups, it being possible optionally for the amino groups to be present in blocked form, although this is generally not preferred.

They may for example be aliphatic polyamines, such as diethylenetriamine, triethylenetetramine, dipropylenetriamine, tetraethylenepentamine, 3-aminomethyl-3,5,5-trimethylcyclohexylamine, m-xylylenediamine, or polyoxypropylenediamine, cycloaliphatic and/or heterocyclic polyamines, such as 4,4′-diamino-3,3′-dimethyldicyclohexylamine, cyclohexylaminopropylamine, or N-aminoethylpiperazine, polyaminoamides, obtainable for example from a dimer fatty acid and a polyamine, such as ethylenediamine, for example, or polyaminoimidazolines. Examples of blocked amine compounds are, for example, polyketimines, obtained by reaction of polyamines with ketones, or cyanoethylated polyamines from the reaction of polyamines with acrylonitrile, such as dicyandiamide in unmodified or modified form.

Frequently also used as amine hardeners are polyamine-polyepoxide adducts or polyaminoamide-polyepoxide adducts. These are obtained from the reaction of polyamines or polyaminoamides, examples being those stated above, with polyepoxides, with the polyamine and/or polyaminoamide being used in excess.

Preference is given to using aqueous amine hardeners which are employed for self-leveling coating systems. Examples of suitable commercial products are Epilink® 701 from AirProducts, Incorez® 148/700 from Incorez, and D.E.H.® 804 from Dow Chemical Co.

The hardener component (B) may optionally comprise one or more other additives. Suitable additive are elucidated further on below.

Solid component (C) comprises a hydraulic inorganic or other mineral binder, which is preferably a cement. Two or more hydraulic inorganic binders may also be used. Component (C) is a solid component and is preferably pulverulent.

Hydraulic inorganic binders are inorganic or mineral binders which are hardenable with water even underwater. Hydraulic inorganic binders here also include those known as latent hydraulic binders, which set with water under the action of adjuvants, such as blast furnace slag, for example.

Examples of suitable hydraulic inorganic binders are hydraulic lime, cement, flyash, rice husk ash, calcined recycling products of the paper industry, slag sand, and blast furnace slag, and mixtures thereof, with cement being particularly preferred. All customary cement grades can be used, particularly a cement according to European standard EN 197. Of course, cement grades in accordance with another cement standard may also be used. It is possible to use one cement or a mixture of different cement grades.

Preferred cements are Portland cements, sulfoaluminate cements, and high-alumina cements, more particularly Portland cement. Mixtures of cements may lead to particularly good properties, Examples are mixtures of at least one Portland cement with either at least one sulfoaluminate cement or with at least one high-alumina cement. The use of white cement is particularly advantageous.

The solid component (C) may further comprise one or more additional additives. Examples are calcium sulfate in the form of anhydrite, hemihydrate gypsum or dihydrate gypsum; and/or calcium hydroxide, various types of sand, or finely ground quartz, silica dust, pozzolans, and auxiliaries and admixtures customary within the cement industry, such as, for example, plasticizers, setting accelerators, water reducers, or deaerating/defoaming agents.

In one particularly preferred embodiment of the invention the multicomponent composition comprises one or more pigments as colorants. In this way a colored composition is obtained, from which colored coatings can be obtained, this being particularly preferred. In this way it is possible for colored compositions and colored coatings to be obtained that differ from the otherwise customary gray compositions and coatings, respectively. Mixtures of two or more pigments are advantageous, in order to produce a desired shade.

The multicomponent composition is especially compatible with pigments in the customary commercial forms, and so a broad palette of shades is possible.

The pigment or pigments may be present in at least one of the components, A), B), or C) and/or in at least one additional pigment component, D).

The pigments may be inorganic or organic pigments. Examples of inorganic pigments are titanium dioxide, carbon black, bismuth pigments, iron oxide pigments, chromium oxides, mixed phase oxide pigments, Prussian Blue, ultramarine, cobalt pigments, and chromate pigments. Examples of organic pigments are azo pigments and polycyclic pigments such as copper phthalocyanine, quinacridone, diketopyrrolopyrrole, perylene, isoindoline, dioxazine and indanthrone pigments.

The pigment or mixtures of pigments may be used as such in solid form, as powder or muller pigment, or as a customary pigment preparation, in the form of a pigment paste, for example. Suitable pigments are all commercially available pigments or pigment preparations. The pigments, for example, can be incorporated directly, by trituration, for example, into the liquid components (A) and (B), or may be introduced in the form of a pigment preparation—a pigment paste, for example. The pigment or pigments in solid form, as muller pigment, for example, may be incorporated by mixing into the solid component (C). It is likewise possible for the pigment or pigments to be held separately, as powder or muller pigment or pigment preparation, in the form of a pigment paste, for example, as an additional pigment component (D), and mixed with the other components only on use.

The multicomponent composition of the invention is advantageous in that commercial pigments or pigment preparations can easily be incorporated homogeneously by mixing into the composition, enabling even non-gray shades for the compositions or coatings in a broad palette.

In one preferred embodiment the multicomponent composition comprises sand, it being possible for the sand to be present in the solid component (C) and/or in an additional component.

As and when required, as well as the three components stated, the multicomponent composition may comprise further, additional components. Examples of such optional additional components are the aforementioned pigment component (D). Furthermore, for example, a portion of the water may be present as a standalone component, added only on mixing of the components prior to use, in order to set the desired amount of water. Sand may optionally also be used in the form of an additional standalone component.

Further optional additives which may be present, in particular, in the binder component (A) and/or in the hardener component (B), but also, optionally, in one or more other components, are additives customarily used within this field, such as, for example, nonreactive diluents, solvents, or film-forming assistants; reactive diluents and extenders, examples being reactive diluents containing epoxide groups, as already mentioned above; polymers, thermoplastic polymers; inorganic and organic fillers, such as ground or precipitated calcium carbonates, barite, talcs, finely ground quartzes, silica sand, dolomites, wollastonites, kaolins, micas, aluminum oxides, aluminum hydroxides, silicas, PVC powders, or hollow beads, for example; fibers; accelerators which accelerate the reaction between amino groups and epoxide groups, examples being acids or compounds that can be hydrolyzed to acids; tertiary amines and salts thereof; quaternary ammonium salts; rheology modifiers, such as thickeners, for example; adhesion promoters, such as organoalkoxysilanes, for example; stabilizers to counter heat, light, or UV radiation; flame retardants; surface-active substances, such as wetting agents, flow control agents, deaerating agents, or defoamers, for example; and biocides.

The multicomponent composition of the invention is a hybrid system which comprises an organic binder composed of the at least one epoxy resin and optionally reactive diluents of the binder component (A), and of the amine hardener of the hardener component (B), and an inorganic binder composed of the hydraulic inorganic binder, preferably cement, in the solid component (C).

The organic binder here is the total amount of epoxy resin and amine hardener, and, if reactive diluent is also used, it is counted among the epoxy resin with regard to the total amount. Based on the total weight, the multicomponent composition comprises at least 8 wt %, preferably at least 10 wt %, and more preferably at least 11 wt %, of organic binder. In general the multicomponent composition comprises not more than 40 wt % and preferably not more than 30 wt % of organic binder, based on the total weight.

The multicomponent composition further comprises preferably 0.5 wt % to 20 wt %, preferably 1.5 wt % to 10 wt %, of pigment, as colorant, based on the total weight.

The multicomponent composition further comprises preferably 8 wt % to 50 wt %, preferably 15 wt % to 40 wt %, of hydraulic inorganic binder, preferably cement or cement in combination with another hydraulic inorganic binder.

The mixing ratio between the binder component (A) and the hardener component (B) may vary within wide ranges. It is preferably selected such that in the multicomponent composition, the stoichiometric ratio of epoxide functionality to amine functionality is in the range from 0.75 to 1.25 (or 75% to 125%).

The amount of water in the multicomponent composition may likewise vary within wide ranges, the amount of water in the multicomponent composition preferably being selected such that the weight ratio of water to hydraulic inorganic binder, preferably cement, is in the range from 0.3 to 0.8. Water is present in the hardener component (B). Water may also be present in the binder component (A), and this is also preferred. Furthermore, a portion of the water may may also be added separately as a standalone component.

The invention also relates to a method for producing a coating, preferably a floor coating, with the multicomponent composition of the invention, the method comprising the following method steps: a) mixing the binder component (A) and the aqueous hardener component (B), b) adding the solid component (C) to the mixture obtained in step a), with stirring, to give a coating composition, c) applying the resulting coating composition to a substrate, d) optionally smoothing or deaerating the applied coating composition, and e) curing the applied coating composition, to give the coating.

Application of the coating composition and curing take place advantageously for example at temperatures in the range from 5 to 40° C.

As elucidated, the multicomponent composition may also comprise one or more additional components. The nature and sequence of the addition of the additional components to the mixture of the composition is arbitrary, but preferably one or more additional liquid components, if used, are admixed in step a). One or more additional solid components, if used, are preferably admixed in step b).

Prior to the application of the coating composition, the substrate may be provided with a primer. It is possible, furthermore, to apply a top coat as sealing coat to the applied coating composition.

The substrate may comprise any, arbitrary material. Preferably it is a floor covering, made of concrete, mortar, or screed, for example, which may optionally have a coating, such as a scratchwork filler coating or a primer coating and/or another customary coating.

The curing reaction begins with the mixing of the multicomponent composition. The epoxy groups of the epoxy resin and optionally of the reactive diluent react with the reactive NH hydrogens to form the organic binder matrix, while the hydraulic inorganic binder with the water, with hydration reactions, forms the inorganic binder matrix, as a result of which the composition ultimately cures. The present invention hence also describes a cured composition or coating.

The multicomponent composition may be used as mortar. It is particularly suitable for producing coatings or seals, more particularly as a floor coating or floor seal.

Examples follow which elucidate the invention, but which are not intended in any way to restrict the scope of the invention.

### EXAMPLES

Commercial products used are as follows:

| | |
|---|---|
| D.E.H. ® 804 | aqueous amine hardener, polyamine-polyepoxide |
| | adduct, solids content 70 wt %, Dow Chemical |
| | Company |
| Byk-019 ® | silicone-containing defoamer, Byk |
| EFKA ®-2550 | defoamer, modified polydimethylsiloxane, BASF |
| Hostatint ®White | binder-free aqueous pigment preparation, pigment |
| R 30 | content 70 wt %, Clariant |
| Colanyl ®Blue | binder-free aqueous pigment preparation, pigment |
| B2G 131 | content 47 wt %, Clariant |
| Hostatint ®Pink E 30 | binder-free aqueous pigment preparation, pigment |
| | content 42 wt %, Clariant |
| Colanyl ®Black | binder-free aqueous pigment preparation, pigment |
| N 131 | content 40 wt %, Clariant |
| Sika ® Repair/ | aqueous epoxy resin dispersion, |
| Sikafloor ® | |
| EpoCem ® Module A | solids content about 64 wt %, EEW 295 |
| | Sika Schweiz AG |
| Sikafloor ®-81 | pulverulent, cement-containing component, |
| EpoCem ® (C) | cement content about 37%, Sika Schweiz AG |
| White cement | cement CEM I 52.5R, Valderrivas |

Three-component compositions were formulated in accordance with table 1 below. Table 2 lists properties of examples 1 and 2.

TABLE 1
Composition

| | Example 1 | | Example 2 | |
|---|---|---|---|---|
| | (Parts by | | (Parts by | |
| Raw material | weight) | | weight) | |
| Component A | | | | |
| Sika ® Repair/ | | 24.600 | | 14.000 |
| Sikafloor ® EpoCem ® | | | | |
| Module A | | | | |
| Component B | | 26.125 | | 16.000 |
| D.E.H. ® 804 | 14.900 | | 8.500 | |
| BYK-019 ® | 0.150 | | 0.080 | |
| EFKA ®-2550 | 0.075 | | 0.040 | |
| Water | 9.500 | | 5.400 | |
| Hostatint ® white R 30 | 1.250 | | 1.733 | |
| Hostatint ® pink E 30 | 0.157 | | 0.156 | |
| Colanyl ® blue B 2 G 131 | 0.067 | | 0.066 | |
| Colanyl ® black N 131 | 0.026 | | 0.026 | |

| Component C | |
|---|---|
| White cement | 49.275 |

| | |
|---|---|
| Sikafloor ®-81 EpoCem ® (C) | 70.000 |

TABLE 2
Properties

| | Example 1 | Example 2 |
|---|---|---|
| Organic binder content [wt %] | 25.8 | 14.7 |
| Pigment content [wt %] | 1.1 | 1.5 |
| Cement content (Z) [wt %] | 49.3 | 25.9 |
| Water content (W) [wt %] | 23.0 | 13.2 |
| W/C ratio | 0.5 | 0.5 |
| Stoichiometric ratio [in %] | 97.7 | 97.4 |
| Density of mixture while still liquid [g/ml] | 1.6 | 1.9 |

### Preparation of Component B:

The aqueous amine compound is introduced initially into a suitable vessel and the further raw materials are added with stirring using a dissolver in the order stated.

### Preparation of the Coating Composition:

Components A and B are mixed with a paddle stirrer in the mixing ratio indicated and, after thorough mixing (about 1-2 minutes), component C is added continuously and mixing is continued for approximately 3 minutes.

### Coating Example 1

The formulation of Example 1 is poured onto a fiber cement slab primed with an EP resin, and is spread using a roller. The amount of material consumed is approximately 400 g/m². With this method of working, the formulation can be spread easily and after hardening has a satin-sheen textured surface.

### Coating Example 2

The formulation of Example 2 is poured onto a fiber cement slab primed with an EP resin, and is spread uniformly using a toothed applicator. Subsequently the formulation is additionally deaerated by means of pins. The consumption of material in this example is about 4 kg/m², thus giving a coating approximately 2 mm thick. The working here conforms to that of a conventional, solvent-free EP system. The surface obtained after hardening has a satin-sheen appearance, which features a surface texture as a result of the sand included.

1. A multicomponent composition comprising
A) a binder component (A) comprising at least one epoxy resin,
B) an aqueous hardener component (B) comprising at least one amine compound as amine hardener and water, and
C) a solid component (C) comprising at least one hydraulic inorganic binder,
wherein the multicomponent composition, based on the total weight, comprises at least 8 wt % of organic binder, the total amount of epoxy resin and amine hardener constituting the organic binder.

2. The multicomponent composition as claimed in claim 1, wherein the multicomponent composition further comprises at least one pigment as colorant in at least one of the components, A), B), or C), and/or in at least one additional pigment component D), the pigment being used in the form of a pigment preparation.

3. The multicomponent composition as claimed in claim 2, wherein the multicomponent composition, based on the total weight, comprises 0.5 wt % to 20 wt % of the at least one pigment as colorant.

4. The multicomponent composition as claimed in claim 1, wherein the multicomponent composition, based on the total weight, comprises 8 wt % to 50 wt % of hydraulic inorganic binder.

5. The multicomponent composition as claimed in claim 1, wherein the multicomponent composition, based on the total weight, comprises not more than 40 wt % of organic binder.

6. The multicomponent composition as claimed in claim 1, wherein the multicomponent composition the weight ratio of water to hydraulic inorganic binder, is in the range from 0.3 to 0.8, it also being possible for some of the water to be added as a standalone component.

7. The multicomponent composition as claimed in claim 1, wherein the at least one amine compound is a polyamine, a polyaminoamide, a polyamine-polyepoxide adduct, a polyaminoamide-polyepoxide adduct, or a mixture of at least two of these compounds.

8. The multicomponent composition as claimed in claim 1, wherein the composition further comprises sand, the sand being present in the solid component (C) and/or in an additional component.

9. The multicomponent composition as claimed in claim 1, wherein the binder component (A) is an aqueous binder component, the at least one epoxy resin being present in dispersion in water.

10. The multicomponent composition as claimed in claim 1, wherein the at least one epoxy resin comprises at least one epoxy resin and a reactive diluent.

11. A method for producing a coating or seal, with a multicomponent composition as claimed in claim 1, the method comprising the following method steps:
a) mixing the binder component (A) and the aqueous hardener component (B),
b) adding the solid component (C) to the mixture obtained in step a), with stirring, to give a coating composition,
c) applying the resulting coating composition to the substrate,
d) optionally smoothing or deaerating the applied coating composition, and
e) curing the applied coating composition, to give the coating or seal.

12. The method as claimed in claim 11, wherein step a) one or more additional liquid components are admixed and/or in step b) one or more additional solid components are admixed.

13. The method as claimed in claim 1, wherein before the coating composition is applied, the substrate is provided with a primer, and/or the applied coating composition is sealed with an additional topcoat.

14. A coating or seal, more particularly a floor coating or floor seal, obtainable by a method as claimed in claim 11.

15. The multicomponent composition as claimed in claim 1 is used as mortar, seal, or coating.
